(19) United States
(12) Patent Application Publication
(10) Pub. No.: US 2016/0080274 A1
(43) Pub. Date: Mar. 17, 2016

(54) MULTI-PROTOCOL CONTROL IN A HYBRID BROADCAST PRODUCTION ENVIRONMENT

(71) Applicant: GVBB HOLDINGS S.A.R.L., Luxembourg (LU)

(72) Inventors: Charles S. MEYER, Nevada City, CA (US); Roberto GRANDILLO, St-Jean-Sur-Richelieu (CA)

(21) Appl. No.: 14/850,887

(22) Filed: Sep. 10, 2015

Related U.S. Application Data
(60) Provisional application No. 62/050,036, filed on Sep. 12, 2014.

(51) Int. Cl. H04L 12/801; H04L 12/853

(52) U.S. Cl. CPC H04L 47/18; H04L 47/2416

(57) ABSTRACT

A method, a system, an apparatus, and a computer program product for multi-protocol end-to-end control in a hybrid broadcast production environment. A topology model of a hybrid broadcast production system is stored, the topology model comprising connections between pieces of equipment and characteristics of each piece of equipment, the equipment including at least one broadcast router and one IP router. After receipt of information regarding a received media signal and of an intended destination for the media signal, a traffic flow for the media signal is determined based on the stored topology model of the system. Then, the broadcast router and IP router are controlled to enable the determined traffic flow.

### CROSS-REFERENCE TO RELATED APPLICATION(S)

This application claims the benefit of U.S. Provisional Application Ser. No. 62/050,036, entitled “Multi-Protocol Control in a Hybrid Broadcast Production Environment” and filed on Sep. 12, 2014, which is expressly incorporated by reference herein in its entirety.

### BACKGROUND

Television production involves assembling source material such as a signal from one or more cameras, microphones, etc. into sequences with defined transitions or graphics, to create a program. Source material for live broadcast is typically captured from multiple cameras, video servers, pre-produced material and graphics, assembled and then broadcast directly from a control room or stored for broadcast at a later date. For example, a small television news studio may include multiple cameras, each with high definition and standard definition video output feeds, return video monitor feeds, audio feeds to and from camera operator headsets, in-studio monitors and teleprompters, multiple microphones, in-ear audio monitors for cueing purposes or for communicating from a producer to on-air talent and other persons involved in the broadcast, audio and video playback systems for pre-recorded segments, remote communications systems for on-location or live remote video feeds, audio mixing consoles, video switchers and routers, satellite uplink transmitters, connections to terrestrial transmitters, and lengths of wiring.

Typical broadcast environments, such as television or radio studios or related production environments may include hundreds of discrete media sources and destinations and thousands of potential signal paths. As studios increase in size, the number of devices and interconnections grows.

Multiple connections might be involved in communicating the signal, which is received from a camera, microphone, etc. to a specific destination. Routing the signal may involve sending the signal via routers and equipment using different types of protocols.

### SUMMARY

In an aspect of the disclosure, a method, a system, a computer program product, and an apparatus are provided for multi-protocol end-to-end control in a hybrid broadcast production environment. The apparatus or system store a topology model of a hybrid broadcast production system, the topology model comprising connections between pieces of equipment and characteristics of each piece of equipment, the equipment including at least one broadcast router and one IP router. When information regarding an incoming media signal is received along with an intended destination for the media signal, the apparatus or system determines a traffic flow for the media signal based on the stored topology model of the system; and controls the at least one broadcast router and one Internet Protocol (IP) router to enable the determined traffic flow.

Additional aspects include a control method for multi-protocol end-to-end control in a hybrid broadcast production environment comprising: storing a topology model of a hybrid broadcast production system, the topology model comprising connections between pieces of equipment and characteristics of each piece of equipment, the equipment including at least one broadcast router and one IP router; receiving information regarding a received media signal; receiving an intended destination for the media signal; determining a traffic flow for the media signal based on the stored topology model of the system; and controlling the at least one broadcast router and one Internet Protocol (IP) router to enable the determined traffic flow.

The IP router may be capable of in-band control and out-of-band control, and wherein the IP router may be controlled using out-of-band control. Such out-of-band control may include provisioning the IP router and switching the IP router

The method may further include controlling the IP router using a software defined network (SDN) control interface. The SDN control interface may use a protocol translator to control the equipment in the system.

The broadcast router may comprise, e.g., a Serial Digital Interface (SDI) router. The determined traffic flow may comprise converting the ingested signal between an SDI signal and an IP data packet. Thus, the method may further include directing the signal to a gateway capable of converting the signal between an SDI signal and an IP signal. The control system, e.g., may automatically determine whether the signal is in a correct format for the equipment within the traffic flow. When it is determined that the signal is not in the correct format for at least one piece of equipment within the traffic flow, the control system may generate a notification to a user of the incorrect format and receive user instructions for adjusting the signal types. Alternately, the system may automatically select a piece of equipment, such as a conversion gateway, to convert the signal to the necessary type before routing the signal according to the data flow.

The topology model may be received manually or may be automatically generated by probing the equipment within the broadcast production system. The topology model of the probed equipment may be received and/or stored in a graphical model of the system topology.

The method may further include bundling related streams, including receiving an indication of a relationship between separate media signals; grouping independent IP streams for the separate media signals; and instructing the IP router to perform a parallel switch for each of the grouped IP streams. The separate signals comprise at least two of a video signal, an audio signal, and a time code signal.

The method may further include managing bandwidth within the hybrid broadcast production system. Managing bandwidth may include, in one example, instructing the IP router when to generate a multi-cast group. It may further include instructing the IP router to remove and/or ad streams to the multi-cast group.

Managing bandwidth may include selecting parameters of the data flow to control quality of service (QoS) of the data flow.

In another example, managing bandwidth may include determining an amount of available bandwidth in a network segment between two IP routers; determining the number of signals of each type that can be assigned to the network segment; and controlling the IP routers based on the determinations. Additionally, the method may include controlling an SDI router to choose the signals of each signal type.

### BRIEF DESCRIPTION OF THE DRAWINGS

FIG. 1 illustrates an example diagram of a broadcast control system in accordance with aspects presented herein.

FIG. 2 illustrates an example diagram of a broadcast control system in accordance with aspects presented herein.

FIG. 3 illustrates an example diagram of a broadcast control system including conversion between SDI and IP signals in accordance with aspects presented herein.

FIG. 4 is a table showing example broadcast connections in accordance with aspects presented herein.

FIG. 5 illustrates an example flow chart of a method of broadcast control in accordance with aspects presented herein.

FIG. 6 illustrates an example flow chart of a method of broadcast control in accordance with aspects presented herein.

FIG. 7 illustrates an example flow chart of a method of broadcast control in accordance with aspects presented herein.

FIG. 8 is a block diagram of an example broadcast control system in accordance with aspects presented herein.

FIG. 9 illustrates an example system diagram of various hardware components and other features, for use in accordance with aspects presented herein.

FIG. 10 illustrates is a block diagram of various example system components, in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Broadcast routers for Audio, Video, Time Code and control are often simple crossbars that involve uni-directional data flow.

A router control systems may comprise software applications allowing GUI control panels and hardware control panels to make takes, or cause switches to happen. Every router vendor has their own command protocol. It is a requirement for a router control system to communicate using at least the most popular protocols.

Internet Protocol (IP) routers may be used for routing data. For a media signal, IP protocol packets comprise the media signal payload, and then, Ethernet Frames comprise the IP Packets. A data packet comprises a packet header that includes IP addresses including the source address and destination address, and other metadata used to route and deliver the packet. The data to be delivered is encapsulated within the IP packet structure so that the packet is delivered based on the IP addresses in the packet headers.

For “in-band” control, an IP router uses intelligent packet processing to learn connections between ports connected to it, and in addition, the IP streams inside the ports. There can be more than one IP stream per Ethernet network segment. The IP router builds a router map table that stores the connection relationships.

As video, audio and other media data, currently each with having its own physical layer, are wrapped into IP and Ethernet, it is important to provide inter-operability for traditional broadcast routers and IP routers.

As IP routers have evolved, it has become required for certain operations, such as Video on Demand (VOD) played into the home, to control the IP router directly, rather than let the IP router “learn” the map. Using Software Defined Networking (SDN) the router may be fed the map table directly. SDN involves an approach to computer networking that allows network administrators to manage network services through abstraction of lower level functionality. This is done by decoupling the system that makes decisions about where traffic is sent (the control plane) from the underlying systems that forward traffic to the selected destination (the data plane).

For “out-of-band” control, for example, external software may be used to generate a map table, whether in an automated manner or with information entered by a user, and then, using a protocol specific to the IP router vendor, the Map Table is fed directly to the IP router.

Broadcast routers typically make hundreds of takes every video frame, which is 30 msec. These takes may be simultaneous. An IP router might do a few, 5 or 6, and then, only after it learned them.

Out-of-band control of a router increases its usefulness to a broadcast production system. For example, an SDN can be useful to switch single signals.

Human operators, particularly during live production, determine how signals are connected to different equipment.

It is too slow and non-deterministic to have the human operator control the IP switch. Instead, with the SDN approach, the Human operator can still use tradition router control panels (Human interface boxes with buttons and lights for visual feedback). These control panels, hardware or software are simple. They basically allow the user to call up a destination, select the source to assign to, and hit the take button.

The response can be instant and the media signal, such as video, can be taken at a deterministic point in time.

A SDN control, having aspects described herein, can be used to manage all these user interface devices. It may create and maintain a logical map table. Then, it can associate that logical map table with the Broadcast router, and the IP router. In the case of the broadcast router, the physical address is typically the physical number of the BNC connector on the rear of the panel. In the case of the IP router, the address is the IP Source/Destination address for the data payload, which in turn, is associated with the Ethernet MAC address for the network segment carrying the IP stream. This Ethernet MAC address also has a Source/Destination.

Now, when a user hits the three buttons: Destination, Source, and Take, the logical Destination and Source can be mapped to either a Physical BNC, or a MAC/IP. In a first example, control may be directed only to the broadcast router. In a second example, SDN control may be directed only to the IP router. In another example, control may be directed to both the broadcast router and the IP router.

This control can be accomplished in a manner that is transparent to the user.

The controller, as part of its configuration, is provided the topology information about which types of routers are in which connected graphs. It is provided the information, whether manually or through automatic probing, about which capabilities are available for the IP routers.

Then, using its SDN capability, it can provide the capabilities just described.

The IP router may be switched, e.g., by sending new map tables via a protocol translator, e.g., software such as Open Flow, or Open Daylight. The SDN may comprise vertical operation in order to manage a vertically accurate IP router, for example.

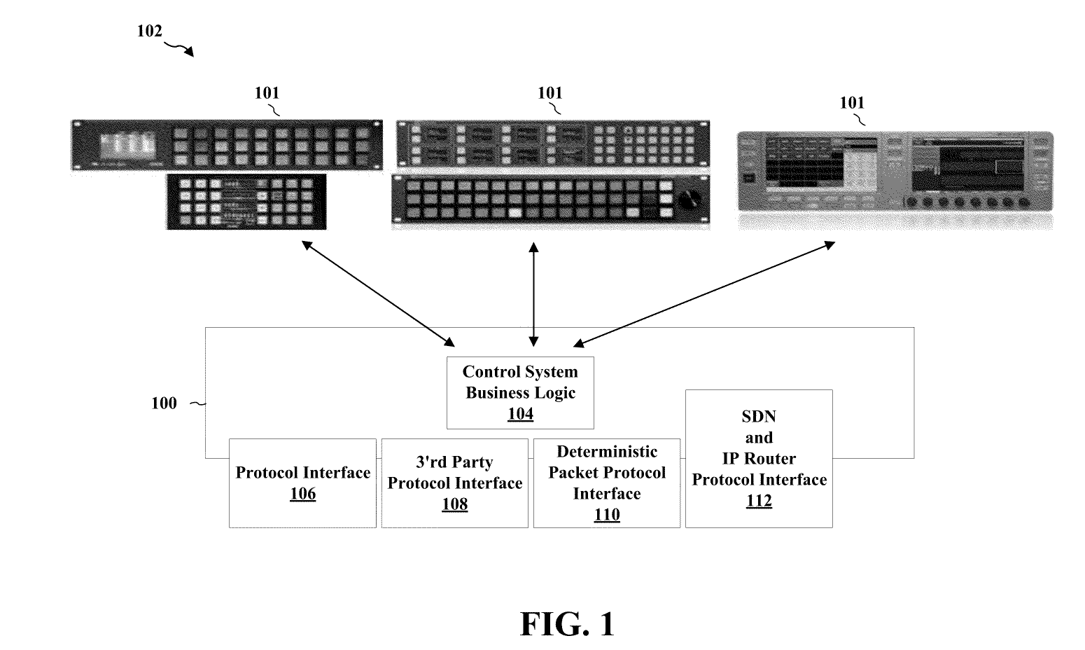

FIG. 1 illustrates an example control system 100 for multi-protocol end-to-end control in a hybrid broadcast production environment 102. The broadcast production environment may include many different types of equipment 101 each having its own protocol. The control system 100 includes controller business logic 104 that is capable of multi-protocol communication with the equipment 101. The equipment may include SDI routers and other such equipment that processes an SDI signal as well as IP routers and other equipment that process an IP signal. The equipment and the control system may be made by the same manufacturer. However, the broadcast production environment may also include equipment manufactured by a third party. Thus, the control system 100 includes a protocol interface 106, a third party protocol interface 108, a deterministic packet protocol interface 110, and an SDN and IP router protocol interface 112.

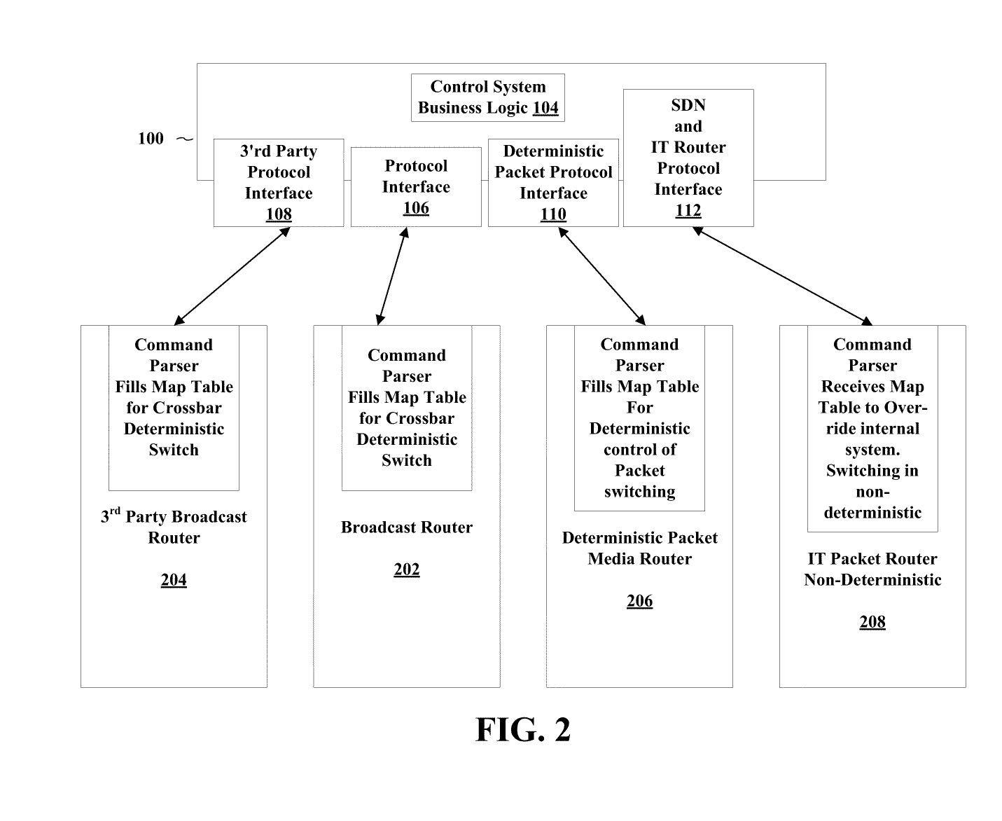

FIG. 2 illustrates an example diagram of a broadcast control system in accordance with aspects presented herein. In FIG. 2, the protocol interface 106 transmits commands to a broadcast router 202, e.g., from the same manufacturer, that are parsed by the broadcast router to fill a map table for a crossbar deterministic switch. The third party protocol interface 108 transmits commands to a third party broadcast router 204 that are parsed by the broadcast router to fill a map table for a crossbar deterministic switch. The third party broadcast router may have a different protocol than broadcast router 202. The deterministic packet protocol interface 110 transmits commands to a deterministic packet media router 206, the commands being parsed by the router to fill a map table for deterministic control of packet switching. The SDN and IP router protocol interface 112 transmits commands to an IP packet router 208 that may be non-deterministic, the commands being parsed by the router to receive a map table to override its internal system.

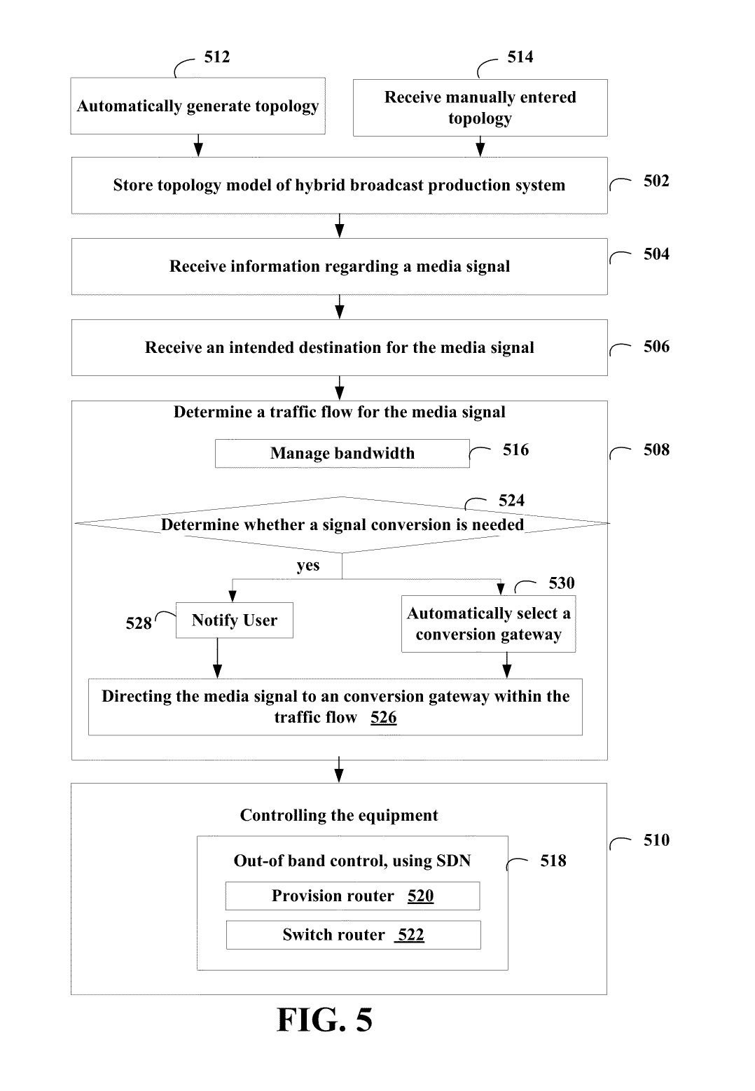

FIG. 5 illustrates a control method for multi-protocol end-to-end control in a hybrid broadcast production environment. At 502, a topology model of a hybrid broadcast production system is stored. The topology model comprises connections between pieces of equipment in the hybrid broadcast production environment and characteristics of each piece of equipment. The equipment includes at least one broadcast router, such as a Serial Digital Interface (SDI) type router, which is controlled using simple control logic. Additionally, the equipment includes at least one IP router, which is controlled using more sophisticated logic that the SDI router. The IP router is capable of operating using, e.g., both in-band and out-of-band control. With in-band control, the IP router uses intelligent packet processing to learn the connections between ports connected to it, as well as the IP streams inside the ports. It builds a router map table that stores the connection relationships. In out-of-band control, the external controller generates the map table, or topology model, and using a protocol specific to the IP router vendor, the map table is fed directly to the IP router.

The topology model may be generated either automatically at 512, e.g., by the controller probing the equipment to identify equipment connected with the broadcast production system and to identify the attributes or characteristics of each piece of connected equipment. A test signal may be initiated to probe the devices connected to the broadcast production system. The probe may determined, e.g., the signal type of the device. Alternately, the topology model may be received as it is entered manually by a user at 514. Once received or generated, the topology model is maintained by the controller. The relationships between pieces of equipment may be entered as a graphical relationship and stored in a graphical database.

At 504, the information regarding a media signal is received. Media signals may be ingested, and their signal content can be examined by equipment in the signal chain. This information can be reported to the controller to effect changes to the equipment in the system. Additionally, the MAC and IP addresses of these signals may be extracted. This may be useful for when a user wants to use Dynamic Host Configuration Protocol (DHCP). In this case, a DHCP map can be built and cross-references to a Static IP map may be created. Either the IP Router would be used to read these DHCP address, or the Hardware itself could report it to the control system.

The media signal may comprise, for example, a video signal from a camera, an audio signal from a microphone, or a time code signal. A single studio may receive signals from many sources, including multiple cameras and multiple microphones, as well as from a database of pre-recorded content, transmissions of live content from a remote location, etc.

At 506, an intended destination is received for the media signal.

In order to direct the media signal from its source to the intended destination, the controller determines a traffic flow at 508 for the media signal based this received information and on the stored topology model of the system. This determination may include evaluations to manage bandwidth of connections within the broadcast production system, as at 516.

Thereafter, the controller issues commands at 510 to control the equipment involved in the determined traffic flow. This includes controlling both the broadcast router and the IP router to enable the determined traffic flow.

The IP router is capable of in-band control and out-of-band control. Thus, the controller may control the IP router using out-of-band control instructions as at 518.

Although the controller may receive and output signals as a component within the traffic flow, in environments having a large number of signals, this may be problematic. Therefore, the controller may be provided outside of the signal path and may direct instructions to the devices within the signal path in order to control the traffic flow for the media signal.

Although the examples describe the application for a single media signal, the broadcast production system and the controller within the system may handle multiple signals and traffic flows for such signals at the same time.

The control system may comprise a software defined network (SDN) having a control interface for controlling the traffic flow within the broadcast production system. The SDN controls the flow to push the media signal to the end device, e.g., the received destination for the media signal. The SDN may control the different devices within the broadcast production system, including, among others, broadcast routers, IP routers, or IP aware routers. As the SDN directs the routers, these devices do not need to be intelligent devices.

This alleviates the need in large systems to configure each of the devices to accurately store the IP addresses for the entire system. Instead, the controller maintains an accurately topology model of the broadcast production system and feeds the necessary information to the devices involved in the traffic flow for a particular media signal. Thus, as devices are added and removed from the network, the controller maintains the modified topology. The SDN controls the streams, so that the other devices do not need to be aware of each change in topology.

The SDN may control the IP router to provisioning the IP router at 520 and switch the IP router at 522. Thus, a traffic flow may be established before a production, and yet, during production modifications can be made to the traffic flow. In this way, after a map table and provision adjustments are made to an IP router, any additional in-band signaling may still be managed by the IP router. Aspects may include ensuring that such in-band signaling is used only to adjust the flow of the signals, not the Map of the signals.

Different IP router manufacturers may have their own protocol. Thus, the SDN control interface may use a protocol translator to control the equipment in the broadcast production system. In one example, a protocol translator using, e.g., software such as OpenFlow or OpenDaylight may be used to control IP routers from different manufacturers. Using the protocol translator, a control system, may configure, e.g., switch, the IP router with out-of-band controls.

Managing Bandwidth

Aspects include managing Media signals across both the baseband video and IP packet video domains.

It is beneficial to be able to share video between routing domains (physical routers) in a plant, rather than having one large router. Typically, some number of connections, referred to as tie-lines, are made between routers. For broadcast, each Tie-Line is made using coax cable, as an example. Each coax cable can carry only one signal regardless of the bandwidth of the signal.

Ethernet can be more powerful. It can carry a varying number of signals based on each signal's bandwidth.

In one example, an IP Gateway card may encapsulate SDI baseband video at 270 Mbps, 1.5 Gps, and 3 Gbps, into IP format and then frame it in Ethernet. These Ethernet trunks can then be connect from the classic Broadcast router, to the IP router.

Thus, the controller may also manage the bandwidth of the broadcast production system, as at 518 in FIG. 5. For example, the controller may manage the available bandwidth between network segments.

For example, the controller, in accordance with aspects presented herein, may use available bandwidth in the Network segment between the two routers, to determine how many signals of each type can be assigned to this network trunk. The controller can then send the MAP table to the IP router, and at the same time, the baseband broadcast router may also be switched based on instructions from the controller.

IP devices may intelligently determine when to join and leave a network in order manage bandwidth in a system. The SDN controller described herein may also instruct devices when to join and when to leave in order to further manage the bandwidth of the system based on its knowledge of the topology model and the need for bandwidth.

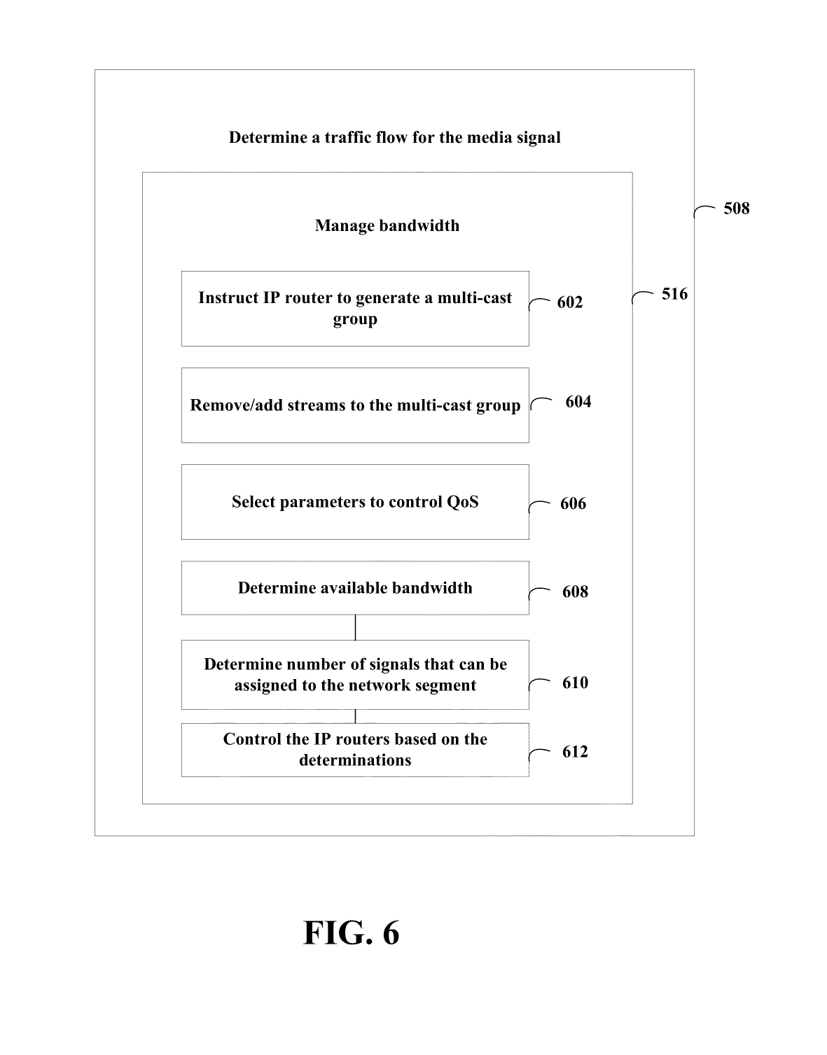

Example aspects of bandwidth management are illustrated in FIG. 6.

In another example, the controller may instruct, e.g., an IP router, when to generate a multi-cast group at 602 and may control the IP router to remove or add streams at 604 to the multi-cast group depending on whether a media signal is needed.

Media signal streams may be dynamically removed from the broadcast production system when they are not needed, in order to increase the available amount of bandwidth.

SDI media signal streams may be selectively converted to IP when it would be beneficial to add additional tie-lines. As each coax cable in an SDI broadcast router can only carry a single signal, regardless of the amount of bandwidth required by the signal, this provides the ability to more efficiently use the bandwidth within the system. An IP trunk, or pipe, can carry multiple signals. Thus, by converting SDI media signals to an IP signal, multiple signals can be communicated on the same IP pipe, thereby dynamically adjusting/adapting tie-lines within the broadcast production system.

Thus, bandwidth may be managed by determining an amount of available bandwidth in a network segment between two IP routers at 608, determining the number of signals of each type that can be assigned to the network segment at 610, and controlling the IP routers based on these determinations at 612.

Additionally, the controller may control an SDI router, e.g., to choose the signals of each signal type.

Parameters of the data flow may be selected at 606 to control quality of service (QoS) of the data flow.

Converting the Signal

As the broadcast production system includes equipment using different protocols, including, for example, SDI and IP equipment, at times, the media signal may need to be converted between an SDI signal and an IP packet according to the characteristics of the equipment in the traffic flow. Thus, the traffic flow may include a conversion of the media signal, such as a conversion between an SDI signal and an IP data packet.

The controller may automatically analyze the traffic flow to determine whether the signal is in a correct format for each piece of equipment within the data flow. This may include, e.g., determining whether a signal conversion is needed at 524. The controller may analyze each connection in the traffic flow to determine whether the signal being communicated from one piece of equipment to the next piece of equipment is

For example, at 526, the controller may direct the media signal to a gateway capable of converting the signal between an SDI signal and an IP signal.

The controller may generate and send a notification to a user at 528 regarding the incorrect format. This gives the user the opportunity to enter instructions directing the media signal to an appropriate conversion gateway in order to convert the media signal to the correct format. The controller may receive the instructions from the user and direct the media signal to the selected conversion gateway within the data flow at 526.

Alternately, once the controller determines that a signal conversion is needed, the controller may automatically select a conversion gateway at 530 to convert the signal before routing the signal according to the traffic flow. Thus, the conversion gateway is established as a part of the traffic flow.

In one example, as part of a traffic flow, a connection may be established from an SDI router directly to an IP router. However, the IP router cannot process the media signal output from the SDI router. Thus, the signal needs to be converted to an IP signal. The SDI media signal can be directed to a conversion gateway that receives the SDI media signal and encapsulates the SDI baseband media signal and adds an IP header that can be interpreted by the IP router. Thus, the SDI baseband media signal is encapsulated and framed in Ethernet. The ability to convert the SDI baseband media signal to an IP signal enables Ethernet trunks to be used to connect between classic broadcast routers and IP routers.

Likewise, if the media signal should be output from an IP router to an SDI router, it can be directed to a conversion gateway that strips out the payload and removes the header in order to convert the IP packet into an SDI media signal.

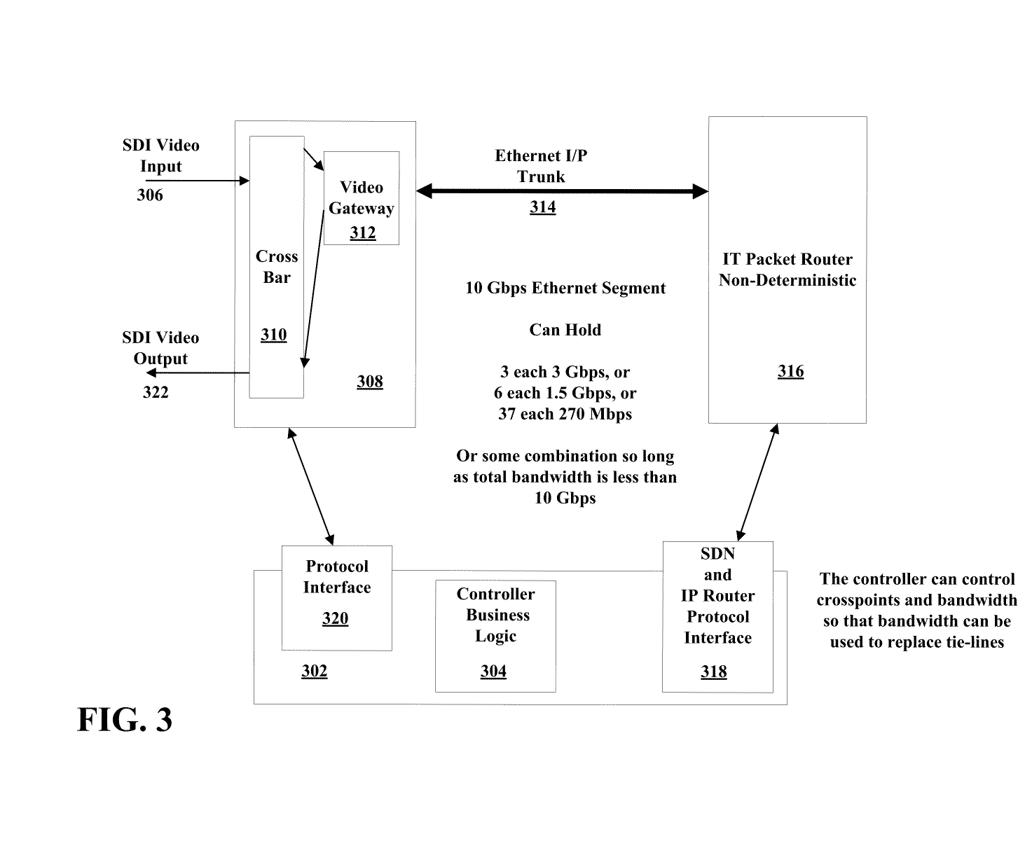

FIG. 3 illustrates aspects of a system diagram involving the conversion of a signal between SDI and IP signals. In FIG. 3, the controller 302 includes business logic 304 for controlling both SDI compatible equipment and IP equipment. When it is determined that a conversion is desired, e.g., from an SDI signal to an IP signal, the SDI baseband signal, e.g., SDI video input signal 306 is directed to a device 308 including a conversion gateway 312. The controller 302 may direct the SDI signal to the conversion device 308 via protocol interface 320. An SDI compatible portion 310 of the device receives the SDI signal 306. The conversion gateway 312 then converts the SDI signal by encapsulating the SDI signal and framing it in Ethernet before outputting via signal to Ethernet trunk 314 to an IP router 316. The controller 302 directs the signal on through the traffic flow by sending directions to the IP router 316 via SDN and IP router protocol interface 318.

Although described in connection with a conversion from SDI to IP, the system illustrated in FIG. 3 is equally capable of converting an IP signal into an SDI signal and outputting SDI output 322.

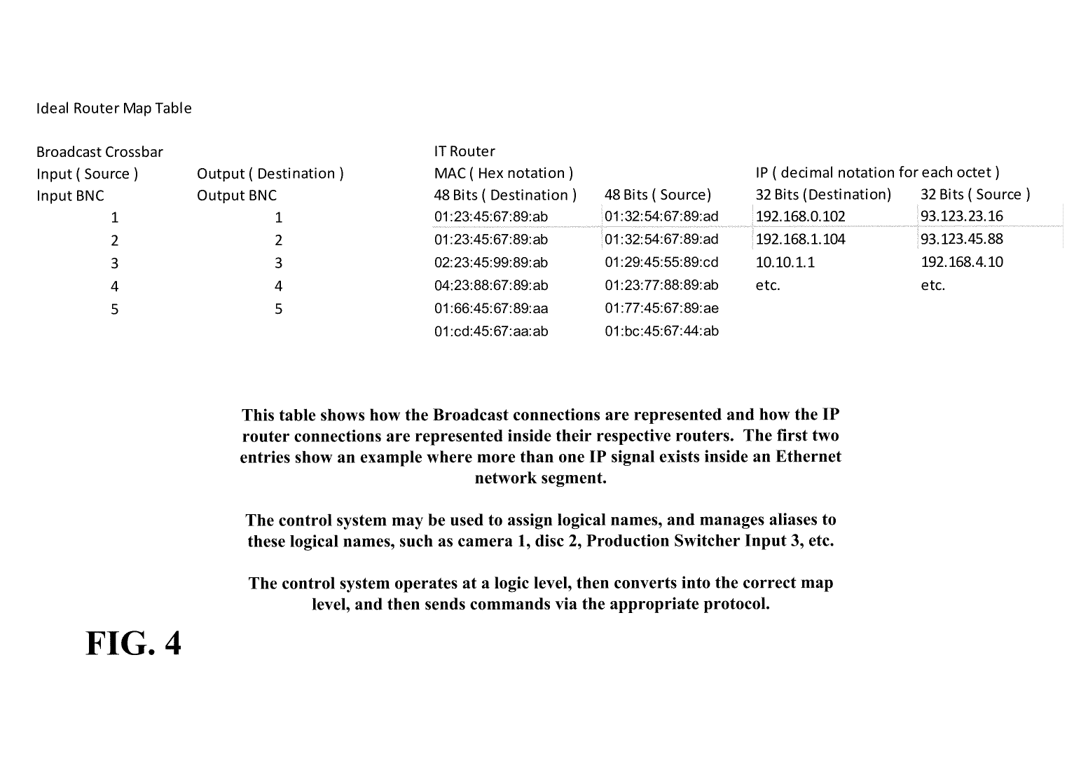

FIG. 4 illustrates a table showing how the Broadcast connections may be represented and how the IP router connections may be represented inside their respective routers. The first two entries show an example where more than one IP signal exists inside an Ethernet network segment. The control system may be used to assign logical names, and manages aliases to these logical names, such as camera 1, disc 2, Production Switcher Input 3, etc. The control system operates at a logic level, then converts into the correct map level, and then sends commands via the appropriate protocol.

Grouping Signals

Media signals are often used as groups. For example, a video signal, audio signal, and time code signal may all relate to each other. IP routers do not relate groups of signals in an optimal way. As one example, video streaming uses Program Association Tables (PATs), Program Map Tables (PMTs), and Program Identifiers (PIDs). Each PID is a value which points out a unique IP address for an elemental stream: audio, video, etc. Each elemental stream gets a unique PID. Then, the PMT is made up of linked groups of PIDS. So, on entry in the PMT is a pointer to the group, or bundle of signals. Each PMT is given a unique PID as well. Finally, at the top, the Program Association Table is given a PID of 0 (Zero). This is required. Only the PAT gets Zero. The PAT table lists the PMT PID values.

These Tables of pointers are carried as IP payloads within an IPTV cable system, as one example. This approach takes too much time and is too expensive to implement for broadcast.

With our approach, the relationships contained within the PAT and PMT tables, essentially pointers to media streams, are managed by the controller.

A user can use the controller system to build the relationships between streams, and then, using the SDN approach, it can rapidly switch groups of related signals in addition to individual signals. In SDI layers of video and the corresponding audio and time code could be switched in a related manner. However, in IP format, each of these related signals would form its own media stream. IP routers would not be aware of the relationship between these correlated streams that should be managed together. As the SDN controller is aware of the correlation through its knowledge of the topology model, it can group signal sources, such as a camera, microphone, recorder, etc., so that the signals from these grouped sources can be switched in parallel throughout the broadcast production system, whether by SDI devices or IP routers.

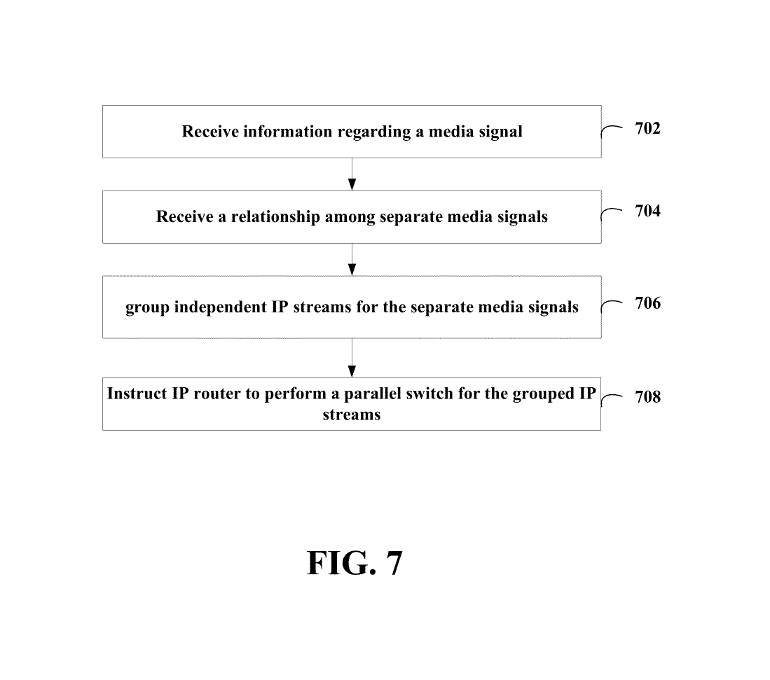

Thus, as illustrated in FIG. 7, the determination of a data flow and the control of the equipment within the hybrid broadcast production system may be based on a relationship among media signals. At 702, the information regarding a media signal is received, similar to the receipt in 504. At 704, an indication of a relationship between separate media signals is received. The separate signals may comprise at least two of a video signal, a corresponding audio signal, and a corresponding time code signal. Each of the separate signals may comprise an independent IP stream.

At 706, the independent IP streams for the separate media signals are grouped. This grouping involves an indication from the controller instructing the IP router to perform a parallel switch for each of the grouped IP streams, as at 708.

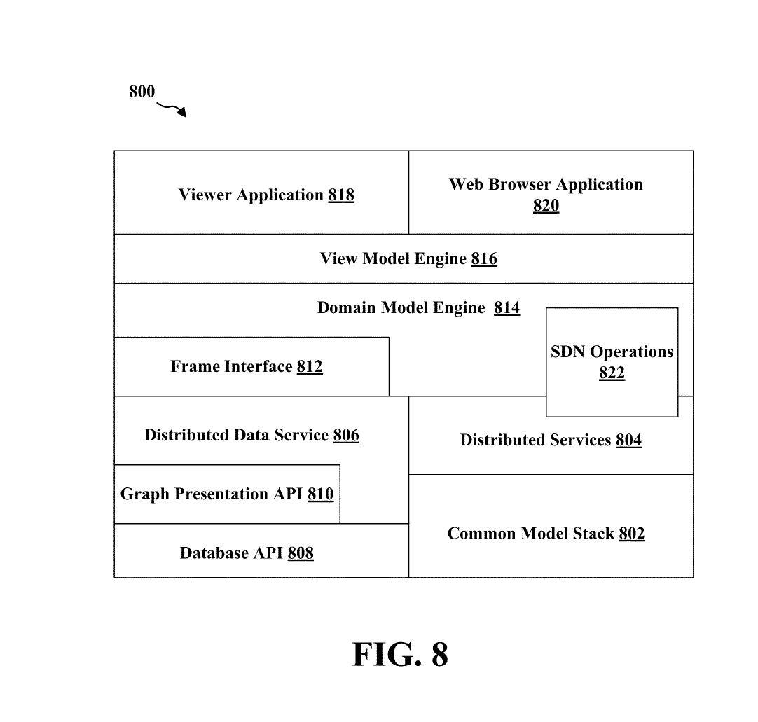

FIG. 8 illustrates a block diagram of an exemplary system 800 for generating, analyzing, and maintaining a graph-based model for broadcast environments and for controlling equipment within a hybrid broadcast production environment. The system includes a common model stack 802 and distributed services model 804. The system also includes a distributed data service 806, which provides a database application programming interface (API) 808 and graph presentation API 810. The system further includes a frame interface 812, domain model engine 814, and view model engine 816. An application, such as a dedicated graph viewer and interaction application 818 or a web browser application 820, is used to interact with and view graphical topology models of the broadcast production system. The system may comprise a model view view model (MVVM) architecture to separate the user interface from the model logic.

The domain model engine 814 is an application, service, server, routine, daemon, or other executable logic for accessing a database and creating a data object to be used by an application 818, 820. The domain model engine 814 provides an observable pattern to a view model engine 816, which may update a user interface, handle user interface events, and/or otherwise direct an application 818,820 to update a visualized graph-model. Similarly, the view model engine 816 may comprise an application, server, service, routine, daemon, or other executable logic for rendering a user interface. The rendered user interface generated by the view model engine 816 may be in any type and format, such as a JavaFX format view or a HyperText Markup Language v5 (HTML5) format view.

In some implementations, the domain model engine 814 may implement interfaces for data configuration and control. For example, in one such implementation, a basic switching interface may be utilized for any device supporting a switch. A control panel may be provided to control any such device like a router. Other interfaces can be built on top of the switching interface so that common device control APIs can implement multiple interfaces for functions such as labeling signals, naming devices, locking switchers, etc. In some implementations, generic interfaces or generic device control interfaces may be used to discover parameters of the device that may be controlled. The domain model engine 814 may also provide dynamic monitoring via the user interface.

The view model engine 816 and domain model engine 814 may include a frame interface 812 or API for exposing a graph as a collection of interrelated domain objects. The frame interface 812 may provide a data schema to represent aspects of the graph model as objects and relationships for more intuitive control and analysis.

The system may include distributed services 804, such as one or more servers including web servers, remote desktop or virtualization services, or any other type and form of distributed services for providing access to the model to applications 818, 820. Similarly, a distributed data service 806 may provide one or more data servers for providing data, including the database underlying the graph model. A database API 308 and/or graph presentation API 810 may be provided for access and editing of the database by applications 818, 820 and/or view model 816 and domain model engine 814. Such APIs may be in any type and form, such as a representational state transfer (RETful) interface or any other such interface.

Graph models for generating and storing the topology model of broadcast production system may include a collection of graphs, vertices, and edges with properties that can be extensible from simple key-value pairs to more complex constructs including embedded documents, maps, tables, or other such data. All other domain models including devices, links, paths, sources, destinations, areas, may be derived from the vertices and edges within the graph models.

The common model stack 802 may comprise an underlying architecture model for supporting specific entities and interfaces of the domain model engine 814 and view model engine 816. The common model stack 802 may comprise a database, data file, data access object, or other such data, and may define the fundamental classes representing vertices, edges, and graphs within the system.

The domain model engine 814 may provide functionality for performing queries and analyses on the graph-model.

The domain model engine 814 and distributed services 804 may include SDN operations 822 for controlling multi-protocol equipment in a hybrid broadcast production environment, as described herein.

Aspects presented herein include a control apparatus for multi-protocol end-to-end control in a hybrid broadcast production environment comprising: means for storing a topology model of a hybrid broadcast production system, the topology model comprising connections between pieces of equipment and characteristics of each piece of equipment, the equipment including at least one broadcast router and one IP router; means for receiving information regarding a received media signal; means for receiving an intended destination for the media signal; means for determining a traffic flow for the media signal based on the stored topology model of the system; and means for controlling the at least one broadcast router and one Internet Protocol (IP) router to enable the determined traffic flow.

Additionally, aspects include an apparatus for multi-protocol end-to-end control in a hybrid broadcast production environment comprising: a memory; and at least one processor coupled to the memory and configured to: store a topology model of a hybrid broadcast production system, the topology model comprising connections between pieces of equipment and characteristics of each piece of equipment, the equipment including at least one broadcast router and one IP router; receive information regarding a received media signal; receive an intended destination for the media signal; determine a traffic flow for the media signal based on the stored topology model of the system; and control the at least one broadcast router and one Internet Protocol (IP) router to enable the determined traffic flow.

The apparatus may include additional components that perform each of the steps of described in connection with FIGS. 5-7. As such, each step in the aforementioned flow charts of FIGS. 5-7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

Several aspects of control systems for a broadcast production environment have been presented with reference to various apparatus and methods. These apparatus and methods described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Aspects described herein may include a computer program product for multi-protocol end-to-end control in a hybrid broadcast production environment, comprising: a computer-readable medium comprising code for: storing a topology model of a hybrid broadcast production system, the topology model comprising connections between pieces of equipment and characteristics of each piece of equipment, the equipment including at least one broadcast router and one IP router; receiving information regarding a received media signal; receiving an intended destination for the media signal; determining a traffic flow for the media signal based on the stored topology model of the system; and controlling the at least one broadcast router and one Internet Protocol (IP) router to enable the determined traffic flow.

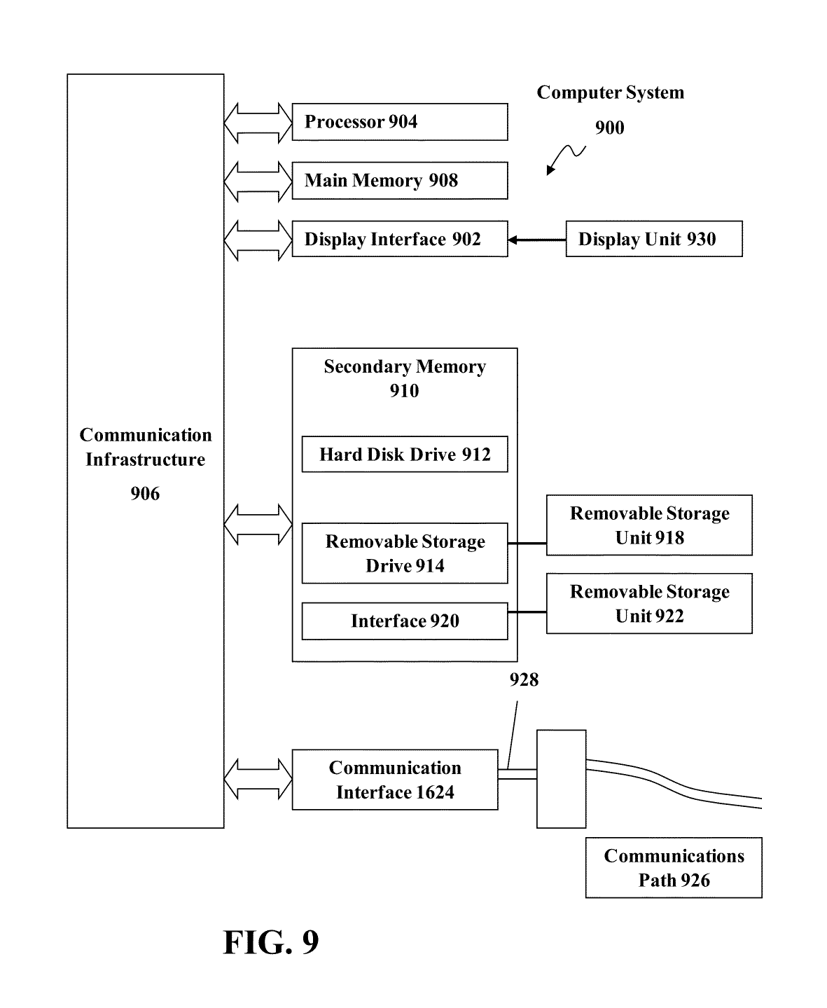

FIG. 9 presents an example system diagram of various hardware components and other features, for use in accordance with aspects presented herein. Aspects presented herein may be implemented using hardware, software, or a combination thereof and may be implemented in one or more computer systems or other processing systems. Aspects include one or more computer systems capable of carrying out the functionality described herein. An example of such a computer system 900 is shown in FIG. 9.

Computer system 900 includes one or more processors, such as processor 904. The processor 904 is connected to a communication infrastructure 906 (e.g., a communications bus, cross-over bar, or network). Various software implementations are described in terms of this example computer system. After reading this description, it will become apparent to a person skilled in the relevant art(s) how to implement aspects presented herein using other computer systems and/or architectures.

By way of example, an element, or any portion of an element, or any combination of elements may be implemented with a “processing system” that includes one or more processors. The components may be software components running in the processor 904, resident/stored in memory 910, e.g., a computer readable medium, one or more hardware components coupled to the processor 904, or some combination thereof. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data.

In alternative implementations, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1780, a hard disk installed in hard disk drive 912, and signals 928. These computer program products provide software to the computer system 900. Aspects may be directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the aspects discussed herein. In particular, the computer programs, when executed, enable the processor 910 to perform the features of the presented herein. Accordingly, such computer programs represent controllers of the computer system 900.

If implemented in software, the functions may be stored on or encoded as one or more instructions or code on a computer-readable medium. Computer-readable media includes computer storage media. Thus, when aspects are the implemented using software, the software may be stored in a computer program product and loaded into computer system 900 using removable storage drive 914, hard drive 912, or communications interface 920. The control logic (software), when executed by the processor 904, causes the processor 904 to perform the functions as described herein. In another example implementation, aspects may be implemented primarily in hardware using, for example, hardware components, such as application specific integrated circuits (ASICs). Implementation of the hardware state machine so as to perform the functions described herein will be apparent to persons skilled in the relevant art(s).

Aspects may also be implemented using a combination of both hardware and software. Accordingly, in one or more example aspects, the functions described may be implemented in hardware, software, firmware, or any combination thereof

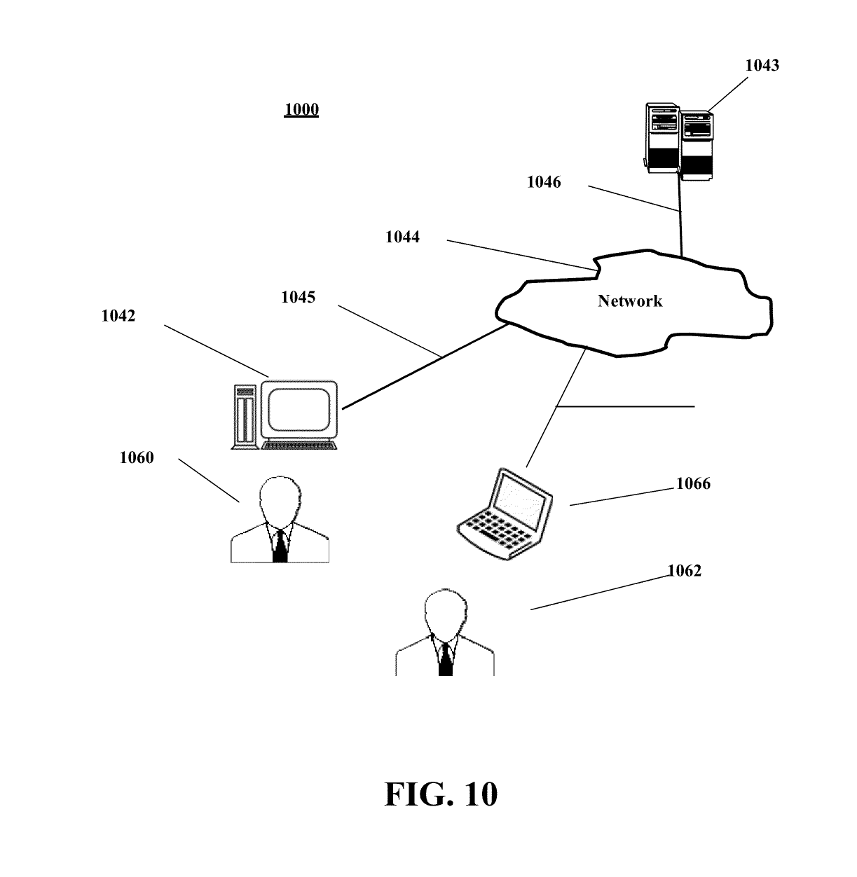

FIG. 10 is a block diagram of various example system components, in accordance with aspects presented herein. FIG. 10 shows a communication system 1000 usable in accordance with aspects presented herein. The communication system 1000 includes one or more accessors 1060, 1062 (also referred to interchangeably herein as one or more “users”) and one or more terminals 1042, 1066. In one aspect, data for use in accordance with aspects presented herein is, for example, input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, and 1064 include, for example, wired, wireless, or fiberoptic links. In another aspect, the method and system presented herein may operate in a stand-alone environment, such as on a single terminal.

While aspects have been described in conjunction with the example implementations outlined above, various alternatives, modifications, variations, improvements, and/or substantial equivalents, whether known or that are or may be presently unforeseen, may become apparent to those having at least ordinary skill in the art. Accordingly, the example implementations of the invention, as set forth above, are intended to be illustrative, not limiting. Various changes may be made without departing from the spirit and scope of the aspects. Therefore, the aspects are intended to embrace all known or later-developed alternatives, modifications, variations, improvements, and/or substantial equivalents.

Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A control method for multi-protocol end-to-end control in a hybrid broadcast production environment comprising:
storing a topology model of a hybrid broadcast production system, the topology model comprising connections between pieces of equipment and characteristics of each piece of equipment, the equipment including at least one broadcast router and one IP router;
receiving information regarding a received media signal;
receiving an intended destination for the media signal;
determining a traffic flow for the media signal based on the stored topology model of the hybrid broadcast production system; and
controlling the at least one broadcast router and one Internet Protocol (IP) router to enable the determined traffic flow.

2. The control method of claim 1, wherein the IP router is capable of in-band control and out-of-band control, and wherein the IP router is controlled using out-of-band control.

3. The control method of claim 1, further comprising:
controlling the IP router using a software defined network (SDN) control interface.

4. The control method of claim 3, wherein the SDN control interface uses a protocol translator to control the equipment in the hybrid broadcast production system.

5. The control method of claim 1, wherein the at least one broadcast router comprises a Serial Digital Interface (SDI) router.

6. The control method of claim 2, wherein controlling the IP router comprises at least one of provisioning the IP router and switching the IP router.

7. The control method of claim 1, wherein the traffic flow comprises converting the received signal between a Serial Digital Interface (SDI) signal and an IP data packet.

8. The control method of claim 7, further comprising:
directing received signal to a gateway capable of converting the signal between an SDI signal and an IP signal.

9. The control method of claim 7, further comprising:
automatically determining whether the received signal is in a correct format for the equipment within the traffic flow.

10. The control method of claim 9, further comprising at least one selected from a group consisting of:
generating a notification to a user of an incorrect format and receiving instructions for adjusting a signal type; and
automatically selecting a piece of equipment to convert the received signal to a correct format type before routing the received signal according to the traffic flow.

11. The control method of claim 1, further comprising:
receiving a manually entered topology of the hybrid broadcast production system, wherein the topology is received as a graphical model of the topology of the hybrid broadcast production system.

12. The control method of claim 1, further comprising:
probing connected equipment and automatically generating a topology of the probed equipment.

13. The control method of claim 1, further comprising:
receiving an indication of a relationship between separate media signals;
grouping independent IP streams for the separate media signals; and
instructing the IP router to perform a parallel switch for each of the grouped IP streams.

14. The control method of claim 13, wherein the separate signals comprise at least two of a video signal, an audio signal, and a time code signal.

15. The control method of claim 1, further comprising:
managing bandwidth within the hybrid broadcast production system.

16. The control method of claim 15, wherein managing the bandwidth comprises at least one selected from a group consisting of:
instructing the IP router when to generate a multi-cast group;
removing or adding streams to the multi-cast group; and
selecting parameters of the traffic flow to control quality of service (QoS) of the traffic flow.

17. The control method of claim 15, wherein managing the bandwidth comprises:
determining an amount of available bandwidth in a network segment between two IP routers;
determining a number of signals of each type that can be assigned to the network segment; and
controlling the at least one IP router based on the determinations.

18. The control method of claim 17, further comprising:
controlling an SDI router to choose the signals of each signal type.

19. A control apparatus for multi-protocol end-to-end control in a hybrid broadcast production environment comprising:
means for storing a topology model of a hybrid broadcast production system, the topology model comprising connections between pieces of equipment and characteristics of each piece of equipment, the equipment including at least one broadcast router and one IP router;
means for receiving information regarding a received media signal;
means for receiving an intended destination for the media signal;
means for determining a traffic flow for the media signal based on the stored topology model of the hybrid broadcast production system; and
means for controlling the at least one broadcast router and one Internet Protocol (IP) router to enable the determined traffic flow.

20. A computer program product for multi-protocol end-to-end control in a hybrid broadcast production environment, comprising:
a computer-readable medium comprising code for:
storing a topology model of a hybrid broadcast production system, the topology model comprising connections between pieces of equipment and characteristics of each piece of equipment, the equipment including at least one broadcast router and one IP router;
receiving information regarding a received media signal;
receiving an intended destination for the media signal;
determining a traffic flow for the media signal based on the stored topology model of the hybrid broadcast production system; and
controlling the at least one broadcast router and one Internet Protocol (IP) router to enable the determined traffic flow.
